(19) United States
(12) Patent Application Publication
(10) Pub. No.: US 2015/0181393 A1
(43) Pub. Date: Jun. 25, 2015

(54) DISTRIBUTION DEVICE FOR TRANSMISSION PACKETS

(71) Applicant: PLANNET ASSOCIATE CO., LTD., Yokohama City (TW)

(72) Inventor: Mamoru SAITOH, Yokohama City (JP)

(21) Appl. No.: 14/137,137

(22) Filed: Dec. 20, 2013

(51) Int. Cl. H04W 4/06; H04N 21/643; H04N 21/6408; H04N 21/2381; H04N 21/6405

(52) U.S. Cl. CPC H04W 4/06; H04N 21/2381; H04N 21/6405; H04N 21/6408; H04N 21/64322

(57) ABSTRACT

A distribution device for transmission packets is provided which distributes, by multicast or unicast, content stream data to a terminal via a communication path. The content stream data comprises closed GOPs that include at least video data and audio data, and is configured hierarchically using a first multiplexed packet stream and a second multiplexed packet stream. The first multiplexed packet stream is configured such that a group of Nα₁ closed GOPs in order from a head is in turn Mβ-multiplexed into a plurality of GOP groups in terms of a GOP. The second multiplexed packet stream is configured such that a group of Nα₂ closed GOPs in order from a head is in turn Mβ-multiplexed into a plurality of GOP groups in terms of a closed GOP. The first multiplexed packet stream and the second multiplexed packet stream are distributed by multicast or unicast with a certain time difference.

### BACKGROUND OF THE INVENTION

1. Technical Field of the Invention

The present invention relates to a distribution device for transmission packets in multicast or unicast.

2. Description of the Related Art

In a wireless communication system that transmits commands from a host computer to a plurality of terminals via a plurality of access points connected through a network, it is proposed to avoid the transmission packet loss in multicast or broadcast by issuing identification numbers to a plurality of channels each comprising an access point and a terminal, and providing time slots, which are allocated in accordance with the identification numbers issued to the channels, to the access points (Patent Literature 1: JP2006-245892A).

### PRIOR ART LITERATURE

### Patent Literature

[Patent Literature 1] JP2006-245892A

### SUMMARY OF THE INVENTION

### Problems to be Solved by the Invention

According to the above prior art, however, even though the transmission packet loss due to channel interference with the adjacent access point can be avoided, the transmission packet loss due to radio wave interference with those other than access points, such as with microwave oven and amateur radio station, cannot be avoided.

Problems to be solved by the present invention include providing a distribution device for transmission packets in multicast or unicast which is able to compensate the transmission packet loss due to radio wave interference.

### Means for Solving the Problems

The present invention provides a distribution device for transmission packets which distributes, by multicast or unicast, content stream data to a terminal via a communication path. The content stream data comprises closed GOPs that include at least video data and audio data, and is configured hierarchically using a first multiplexed packet stream and a second multiplexed packet stream. The first multiplexed packet stream is configured such that a group of Nα₁ closed GOPs in order from a head is in turn multiplexed into a plurality of GOP groups in terms of a closed GOP, i.e., using a closed GOP as the minimum unit. The second multiplexed packet stream is configured such that a group of Nα₂ closed GOPs in order from a head is in turn multiplexed into a plurality of GOP groups in terms of a closed GOP, i.e., using a closed GOP as the minimum unit. The first multiplexed packet stream and the second multiplexed packet stream are distributed by multicast or unicast with a certain time difference. The present invention solves the above problems.

(Note that Nα₁ and Nα₂ are natural numbers, Nα₁<Nα₂, and Nα₂ is multiple of Nα₂.)

### Advantageous Effect of the Invention

According to the present invention, the multiplexed packet streams having different numbers of closed GOPs Nα₁ and Nα₂ (critical values for burst error resistance) are distributed by multicast with a certain time difference, so that mutual correction can be performed during the demultiplexing, and in particular can increase the possibility that the demultiplexing accepts burst error that exceeds the critical values for burst error resistance Nα₁ and Nα₂.

### BRIEF DESCRIPTION OF DRAWINGS

FIG. 1 is a block diagram illustrating a multicast distribution device to which one embodiment of the present invention is applied;

FIG. 2 is a diagram illustrating a data structure of multicast packets according to one embodiment of the present invention;

FIG. 3 is a diagram illustrating a data structure in GOP multiplexing according to one embodiment of the present invention;

FIG. 4 is a diagram illustrating data structures in hierarchical multiplexing according to one embodiment of the present invention;

FIG. 5 is a diagram illustrating an example of correction using hierarchical multiplexing according to one embodiment of the present invention;

FIG. 6 is a data structure diagram for explaining advantageous effects achieved by demultiplexing the multiplexed GOPs according to one embodiment of the present invention;

FIG. 7 is a data structure diagram for explaining advantageous effects achieved by demultiplexing the hierarchically multiplexed GOPs according to one embodiment of the present invention;

FIG. 8 is a diagram illustrating another embodiment for transmitting the hierarchically multiplexed packets according to one embodiment of the present invention;

FIG. 9 is a diagram illustrating still another embodiment for transmitting the hierarchically multiplexed packets according to one embodiment of the present invention;

FIG. 10 is a diagram illustrating an embodiment in which hierarchical multiplexing headers are inserted in IP packets according to one embodiment of the present invention;

FIG. 11A is a diagram illustrating a method of reproducing the hierarchically multiplexed packets according to a comparative embodiment of the present invention;

FIG. 11B is a diagram illustrating a method of reproducing the hierarchically multiplexed packets according to one embodiment of the present invention;

FIG. 12A is a diagram illustrating a method of reproducing subtitles in the hierarchically multiplexed packets according to a comparative embodiment of the present invention;

FIG. 12B is a diagram illustrating a method of reproducing subtitles in the hierarchically multiplexed packets according to one embodiment of the present invention;

FIG. 13A is a diagram illustrating a method of smoothing subtitle packets according to a comparative embodiment of the present invention;

FIG. 13 B is a diagram illustrating a comparative embodiment of a method of smoothing subtitle packets according to one embodiment of the present invention (part 1);

FIG. 13 C is a diagram illustrating a comparative embodiment of a method of smoothing subtitle packets according to one embodiment of the present invention (part 2);

FIG. 13 D is a diagram illustrating a comparative embodiment of a method of smoothing subtitle packets according to one embodiment of the present invention (part 3);

FIG. 14A is a diagram illustrating a method of contracting/smoothing the padding packets according to a comparative embodiment of the present invention; and

FIG. 14B is a diagram illustrating a method of contracting/smoothing the padding packets according to one embodiment of the present invention.

### DESCRIPTION OF THE PREFERRED EMBODIMENTS

Embodiments of the present invention will hereinafter be described with reference to the drawings.

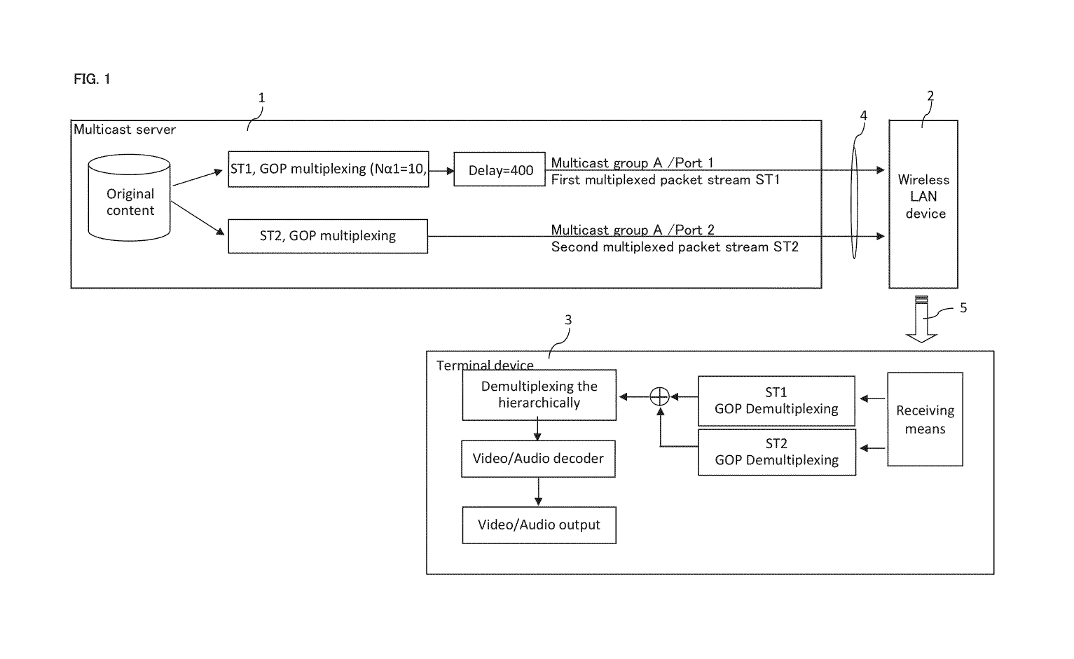

As shown in FIG. 1, the present embodiment relates to a method of distributing, by multicast, content that includes video, audio and subtitles, etc. from a multicast server 1 to a terminal device 3, such as a smartphone, via a WiFi (registered trademark) wireless LAN device 2 (also referred simply to as “wireless LAN device 2”, hereinafter), and relates further to a device and a software program that are associated with the method. Communication lines 4 are provided to transmit data signals between the multicast server 1 and the wireless LAN device 2, while a wireless LAN line 5 is provided to transmit data signals between the wireless LAN device 2 and the terminal device 3. The method of distribution according to the present invention is described here and will be described hereinafter with reference to multicast distribution, but the present invention can also be applied to unicast distribution.

Multicast distribution is to designate a plurality of destinations in a network and transmit the same data to the destinations, and refers to a method in which, when data is once transmitted toward a plurality of destinations, one or more routers on the communication path automatically copy the data in response to destinations and distribute the data from one multicast server 1 to a large number of terminal devices 3. In a broadcast system such as for video distribution, the multicast scheme may often be employed because it can transmit the same video to plural users by one-time transmission and it does not excessively use the available bandwidth at the server side even when the number of destinations increases. According to the transmission scheme using multicast (UDP), however, one-time transmission is only performed in one direction, and retransmission control is not performed, so that this scheme is likely to be affected by radio wave interference, thus frequently resulting in transmission packet loss. In particular in a video distribution system, problems may often occur, such as that video is distorted beyond recognition and a reproduction decoder stops due to some error.

WiFi (registered trademark) wireless LAN is standardized in IEEE 802.11, in which available radiofrequency bands are 2.4 GHz and 5 GHz bands. Some existing wireless LAN products are compatible with both bands, but other typical ones are only for the 2.4 GHz band. As previously described, WiFi (registered trademark) wireless LAN using the 2.4 GHz band involves a problem of radio wave interference such as with microwave oven and amateur radio station. Note that the present invention, in particular the method of distributing transmission packets according to the present invention, is not limited to using WiFi (registered trademark) wireless LAN, and can be applicable to other wireless communication paths and further to wired communication paths. Moreover, the present invention can be applicable to the internet connection and NGN (Next Generation Network) in addition to such a local area communication network.

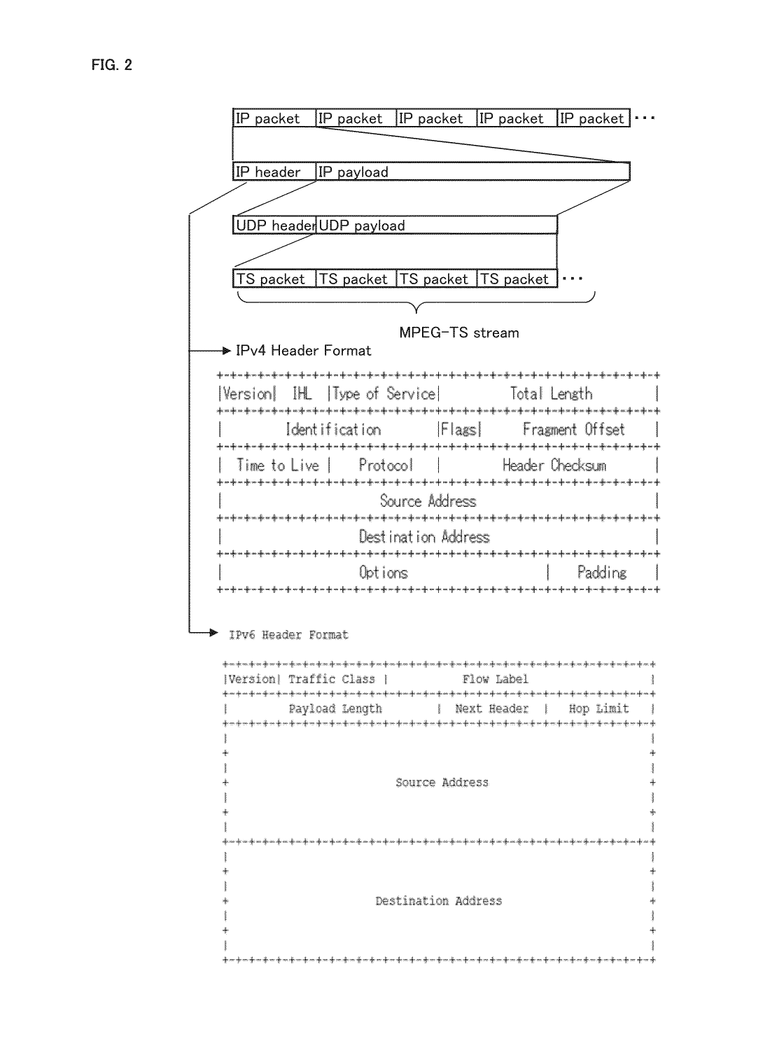

The currently used network protocols include IPv4 and IPv6, for which RFC791 (IPv4) and RFC2420 (IPv6) specification documents and other various documents are disclosed to describe formats and other specs, and respective multicast transfer techniques are also established. According to the present embodiment, the multicast video may be configured as a stream using H.264 video and AAC audio for MPEG-TS container, and the packet structure is illustrated in FIG. 2, to which any of the above IP protocols may be applied.

As shown in FIG. 2, the original content stored in the multicast server 1 shown in FIG. 1 is stream data comprising a plurality of IP packets, each of which includes an IP header′ and an IP payload. One IP payload includes a UDP header and a UDP payload, and one UDP payload is configured to include one or more TS packets. The TS packets are configured as the MPEG-TS stream. The terminal device 3 may extract the MPEG-TS stream from the IP packets distributed from the multicast server 1 and ultimately reproduce the content thereby to allow the user to view and listen to the video, audio and subtitles, etc. Note that the descriptions below will omit the structure of UDP header and UDP payload for descriptive purposes.

Various approaches have been proposed to eliminate or mitigate the packet loss in multicast, among which typical ones are mentioned below, but they suffer from inherent problems.

(1) Packet retransmission request method is a method in which, when packet loss is detected, the lost packets are re-received in response to a retransmission request via unicast for the lost packets, but has problems such as that processes at both the terminal side and the server side will be complicated for detecting the packet loss and performing the retransmission request via unicast, and time delay will occur from the timing of the retransmission request to the timing of receiving the retransmitted packets.

(2) Transmission method using plural communication paths is a method in which plural wireless LAN devices transmit the same multicast packets, and when packet loss occurs, normal packets from another wireless LAN device are used for correction. However, there are problems such as that the system scale may become large and thus may not be suitable for consumer use because plural wireless LAN devices are necessary and the connected wireless LAN devices may have to be monitored and switched as needed, and the reproduced pictures may be distorted beyond recognition if the packets cannot be completely corrected.

(3) Transmission method using plural multicast groups (multicast addresses) is a method in which the plural multicast groups transmit the same multicast packets, and when packet loss occurs, normal packets from another multicast group are used for correction. Another aspect of this method may be such that the plural multicast groups transmit those of the same content but with different encode conditions (e.g., bit rate, etc.), and when packet loss occurs frequently, switching to a multicast group of low bit rate is performed, for example. In such cases, however, additional processes are required to detect packet loss to switch the multicast groups, and plural multicast groups are necessary, so that processes at both the server side and the terminal side will be complicated, thus being problematic. Moreover, the number of multicast groups may have to be further increased when the total amount of content is increased, because the plural multicast groups hold the same content. Furthermore, the reproduced pictures may be distorted beyond recognition if the packets cannot be completely corrected, thus also being problematic.

In view of such circumstances, a method has been contemplated and completed to cope with the multicast packet loss under the conditions below, and is applied to a multicast video distribution system. That is, a method and a system for distribution are provided to satisfy the preconditions that: the system has a simple configuration without the use of plural wireless LAN devices and plural multicast groups; complicated processes are not employed, such as by using single multicast group without performing unicast switching and retransmission request; and the influence of the packet loss to the quality of reproduced video is minimized to suppress noises in the reproduced video and prevent the picture distortion.

As a method to cope with the above-described multicast packet loss, multiplexing the multicast packets and transmitting the packets with a time difference may be considered, but a problem residues that complete correction is difficult if burst error occurs. In addition, if decoding for reproduction is performed when packet loss occurs (when some packets are absent), then there may be cases that the video is disturbed by noises to distort the pictures, and at worst the reproduction decoder stops due to error. According to the present embodiment, a method is achieved which multiplexes IP packets in terms of a closed GOP and further multiplexes using another stream to be transmitted with a certain time difference (this method may also be referred to as “hierarchically multiplexing method”, hereinafter). The descriptions below will be directed to embodiments according to the present invention for a content that contains video and audio, but content that contains only audio can also be distributed using a similar configuration, in which case the GOPs below may be considered as being substituted by frames.

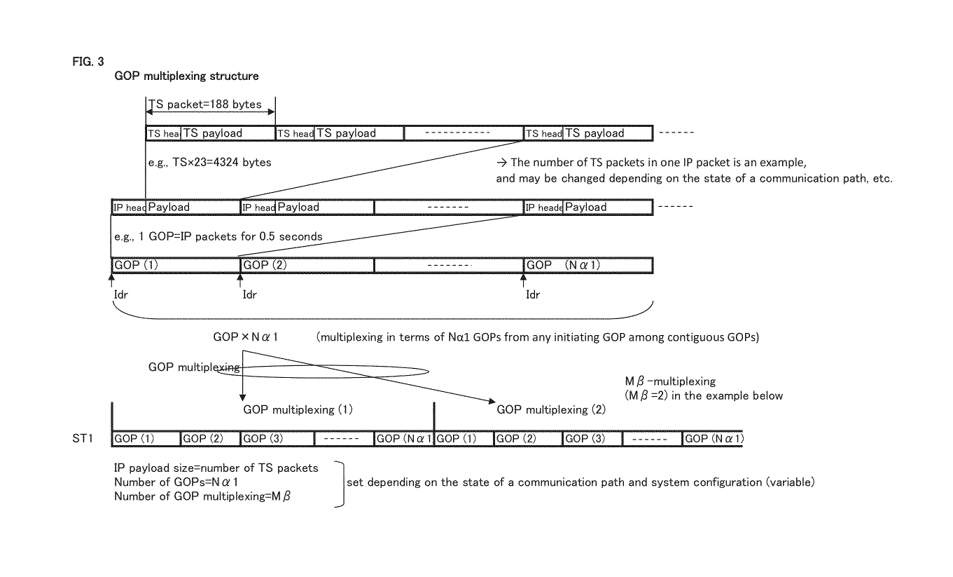

GOP (Group of Picture) is a unit of collection for one reproduction, and closed GOP refers to a stream structure in which the head picture of a GOP must be an Idr-Picture so that any reference is not present between GOPs. In other words, closed GOP can perform, as an independent single GOP, normal reproduction because the relationship with the previous GOP is reset at the GOP head. GOP multiplexing structure according to the present embodiment is shown in FIG. 3, which is a case of a stream of 1GOP=0.5 seconds. Note that the content described below is an example which may be stored in a storage etc. of the multicast server 1 shown in FIG. 1, but the present invention is applicable to various forms of content, such as broadcast content for television etc. and real-time video captured by a live-camera.

The content shown in FIG. 3 assumes that one IP packet comprises 23 TS packets (i.e., 18 bytes×23=4324 bytes), for example, and one GOP comprises IP packets for 0.5 seconds. Nα₁ GOPs from the head of the content (or from any initiating GOP) are extracted, and an Mβ-multiplexed packet stream ST1 is generated in terms of the Nα₁ GOPs. For example, setting Nα₁=10 and Mβ3=2 for a content comprising 400 GOPs means generating each 2 sets of the same data in terms of 10 GOPs, in which case the multiplexed packet stream ST1 is configured such that 2 sets of 10 GOPs each (=20 GOPs) are sequentially generated until 400×2 GOPs are completed.

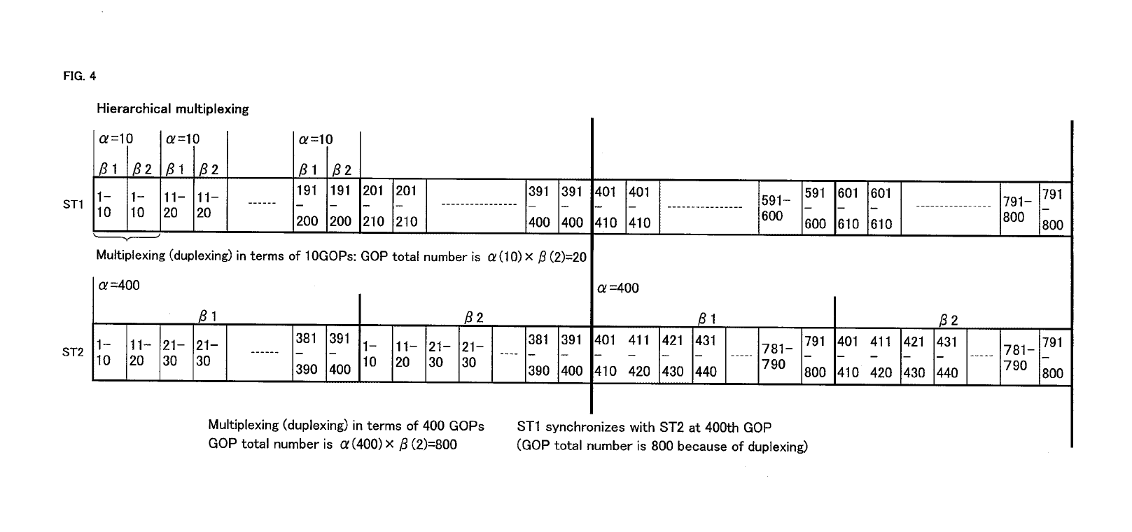

FIG. 4 shows a case of using 800 GOPs (ordinal numbers from 1st to 800th are presented by corresponding numerals) and setting Nα₁=10 and Mβ=2 for a first multiplexed packet stream ST1 and Nα₂=400 and Mβ=2 for a second multiplexed packet stream ST2. In the first multiplexed packet stream ST1, 2 sets of 10 GOPs each (=20 GOPs) are sequentially generated until 800×2 GOPs are completed, while in the second multiplexed packet stream ST2, 2 sets of 400 GOPs each (=800 GOPs) are sequentially generated until 800×2 GOPs are completed. The first multiplexed packet stream ST1 and the second multiplexed packet stream ST2 are in multiple synchronization at the 400th and the 800th GOPs.

According to the present embodiment, the multicast server 1 shown in FIG. 1 sets Nα₁=10 and Mβ=2 to generate the first multiplexed packet stream ST1 with regard to the original content and sets Nα₂=400 and Mβ=2 to generate the second multiplexed packet stream ST2 with regard to the same content. The multicast server 1 then delays the first multiplexed packet stream ST1 by the transmission time for 400 GOPs relative to the second multiplexed packet stream ST2 and transmits them to the wireless LAN device 2 via the communication lines 4 and further to the terminal device 3.

When transmitting the first multiplexed packet stream ST1 and the second multiplexed packet stream ST2 to the wireless LAN device 2 via the communication lines 4, the multicast server 1 uses the same multicast group A but with different multicast address port numbers. According to the embodiment shown in FIG. 1, the first multiplexed packet stream ST1 is transmitted from the multicast address port 1, while the second multiplexed packet stream ST2 is transmitted from the multicast address port 2. Note, however, that one port may be used when the transmission is applied to unicast distribution.

The hierarchically multiplexed first and second multiplexed packet streams ST1 and ST2 are transmitted with a certain time difference thereby to allow the GOPs under the influence of burst error to be shifted in respective streams, so that even if packet loss occurs in either stream, another stream can be used to correct it. Operation and advantageous effect associated with the above will be described later.

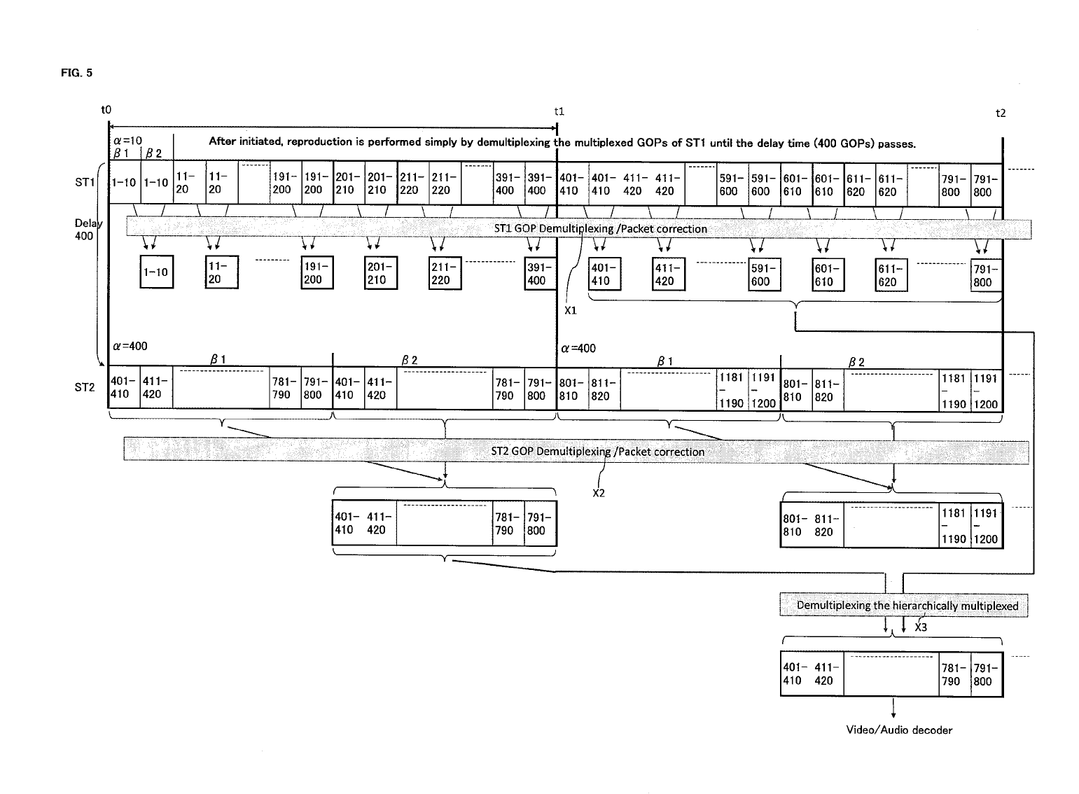

After receiving the first multiplexed packet stream ST1 and the second multiplexed packet stream ST2 from the wireless LAN device 2 using an appropriate receiving means, the terminal device 3 demultiplexes the packet streams ST1 and ST2 and performs packet correction. This operation will be described with reference to FIG. 5.

The horizontal axis in FIG. 5 represents the time axis, in which t0 at the left end denotes the time of initiating reproduction, but it is assumed that the first multiplexed packet stream ST1 and the second multiplexed packet stream ST2 are constantly output and the reproduction mainly uses the second multiplexed packet stream ST2, for example. First, for GOPs 1 to 400 (time period of t0 to t1) immediately after initiating reproduction as shown in the left side, the reproduction may be conducted simply by demultiplexing the multiplexed GOPs of the first multiplexed packet stream ST1 until the delay time (corresponding to 400 GOPs) of the first multiplexed packet stream ST1 passes. This is because the second multiplexed packet stream ST2 has already been distributed at the time of initiating reproduction. In parallel to this, in the demultiplexed GOP packet correction X2 for the second multiplexed packet stream ST2, packet correction is performed, for the precedingly transmitted GOPs 401 to 800, in terms of a GOP using two packets β1 and β2 in the second multiplexed packet stream ST2. The packet correction is thus performed in terms of a GOP, and if there is not any packet that could not have been corrected, then the second multiplexed packet stream ST2 is used for the reproduction, but if any GOP includes one or more packets that could not have been corrected, then the GOP is discarded as GOP packet loss.

During the next time period (t1 to t2), in the demultiplexed GOP packet correction X1 for the first multiplexed packet stream ST, packet correction is performed for the GOPs 401 to 800 in terms of a GOP using two packets β1 and β2 in the first multiplexed packet stream ST1. The packet correction is thus performed in terms of a GOP, and if any GOP includes one or more packets that could not have been corrected, then the GOP is discarded as GOP packet loss.

Next in the demultiplexing of the hierarchically multiplexed GOPs X3, if GOP packet loss occurs in the output stage of the preceding second multiplexed packet stream ST2 (GOPs 401 to 800), then one or more normal GOPs in the output stage of the belated first multiplexed packet stream ST1 (GOPs 401 to 800) are incorporated to be the ultimate output. If, as a result of performing correction in terms of a GOP from the first multiplexed packet stream ST1 to the second multiplexed packet stream ST2, there is any GOP that could not have been corrected, then the GOP is discarded as GOP packet loss. According to the present embodiment, one or more uncorrectable GOPs are discarded in terms of a GOP, and hence, even though some video's skipping occurs, any malfunction during reproduction or picture distortion does not occur. Reproduction operation in relation to this will be described later.

Advantageous effects due to the hierarchical multiplexing of packet streams according to the present embodiment will now be described.

(1) Advantageous Effects Achieved by Demultiplexing the Multiplexed GOPs

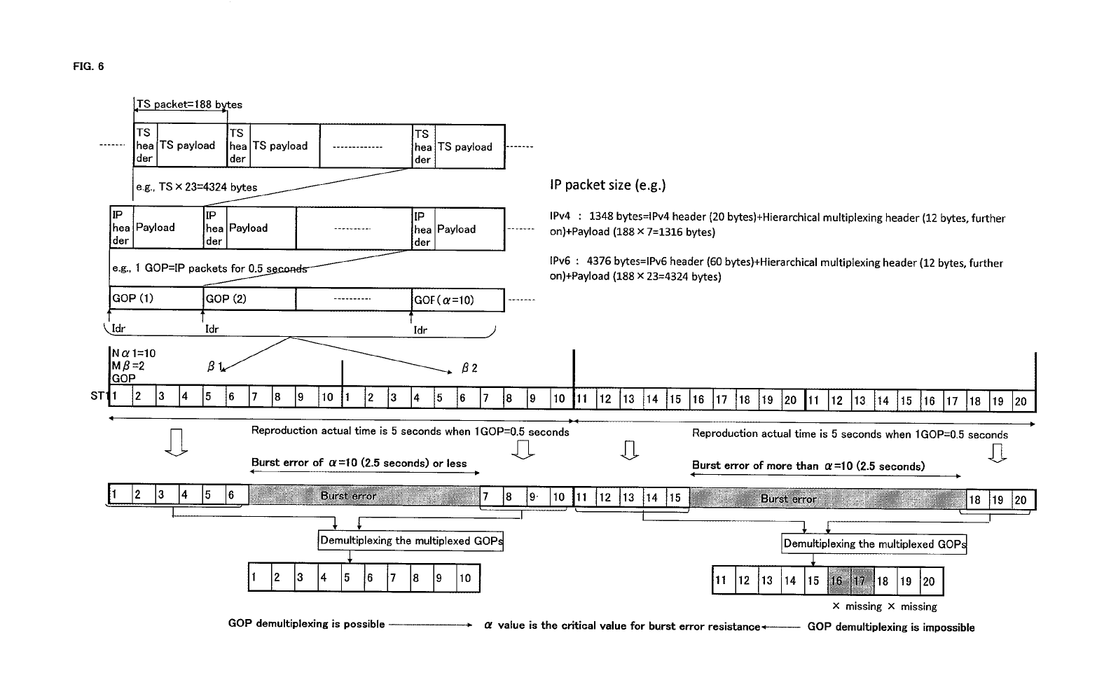

First, as shown in FIG. 6, provided that the original content is duplexed (i.e., Mβ=2, β1 and β2) in terms of 10 GOPs (i.e., Nα₁=10) to generate the first multiplexed packet stream ST1, if burst error occurs in 10 or less GOPs as shown in lower-left of the figure, more specifically if packet loss occurs in the 7th to 10th BODs of β1 and the 1st to 6th BODs of β2, then the packet-lost 7th to 10th BODs of β1 can be corrected using the 7th to 10th BODs of β2, while the packet-lost 1st to 6th BODs of β2 can be corrected using the 1st to 6th BODs of β1.

In contrast, as shown in lower-right of the figure, if burst error occurs in 11 or more GOPs, more specifically if packet loss occurs in the 16th to 20th BODs of β1 and the 11th to 17th BODs of β2, i.e., in the total of 12 GOPs, then the packet-lost 18th to 20th BODs of β1 can be corrected using the 18th to 20th BODs of β2, while the packet-lost 11th to 15th BODs of β2 can be corrected using the 11th to 15th BODs of β1. However, the packet-lost 16th and 17th BODs of β1 cannot be corrected because packet loss also occurs in the 16th and 17th BODs of β2. Therefore, when closed GOPs are merely multiplexed, compensation is possible for burst error occurring in Nα₁ or less GOPs, but not possible for those in more than Nα₁ GOPs. That is, the value of Nα₁ is the critical value for burst error resistance.

(2) Advantageous Effects Achieved by Demultiplexing the Hierarchically Multiplexed GOPs

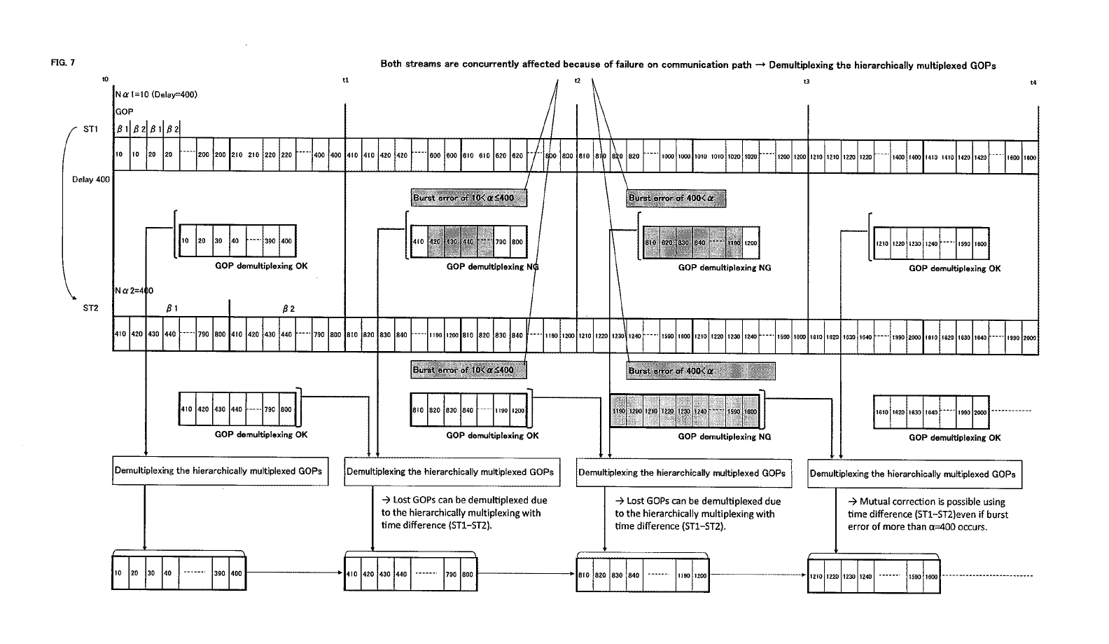

To overcome the burst error occurring in more than Nα₁ GOPs as described in the above “(1) Advantageous effects achieved by demultiplexing the multiplexed GOPs”, it is effective to demultiplex the hierarchically multiplexed GOPs using the second multiplexed packet stream ST2 in which the Nα₁ value is substituted by another value and a certain time difference is provided. Advantageous effects achieved in this case are as follows. For descriptive purposes, one frame of GOPs shown in FIG. 7 represents 10 GOPs (e.g., GOP=10 shown in the figure represents the 1st to 10th GOPs), and the numeral in each frame represents the last number of those GOPs.

According to the embodiment shown in FIG. 7, the original content is duplexed (i.e., Mβ=2, β1 and β2) in terms of 10 GOPs (i.e., Nα₁=10) to generate the first multiplexed packet stream ST1 and also duplexed (i.e., Mβ=2, β1 and (32) in terms of 400 GOPs (i.e., Nα₂=400) to generate the second multiplexed packet stream ST2, and the first multiplexed packet stream ST1 is delayed by 400 GOPs to the second multiplexed packet stream ST2 to be transmitted. That is, if, in the time period t0 to t1 shown in FIG. 7, the 1st to 400th GOPs of the first multiplexed packet stream ST1 are transmitted, then, in the same time period t0 to t1, the second multiplexed packet stream ST2 is transmitted with the 401st GOP (one of GOPs denoted by 410) as the head, which precedes that of the first multiplexed packet stream ST1 by 400 GOPs. This is because preceding the second multiplexed packet stream ST2 of larger Nα₂ (≧Nα₁), i.e., preceding the packet stream of higher burst resistance, has a high possibility that the correction can be performed using its own stream packets without using the other's stream packets for the burst occurring in Nα₂ or less GOPs.

The 1st to 400th GOPs of the first multiplexed packet stream ST1 are demultiplexed without correction and passed to the reproduction process, but if packet loss occurs in 400 or less GOPs in the 401st to 800th GOPs of the first multiplexed packet stream ST1, then correction is performed using the 401st to 800th GOPs of the second multiplexed packet stream ST2 which have been precedingly transmitted. For example, if, in the time period t1 to t2 shown in the figure, packet loss occurs in 370 (≦400) GOPs, i.e., the 411st to 780th GOPs, of the first multiplexed packet stream ST1, then packet loss is compensated using 370 (≦400) GOPs, i.e., the 411st to 780th GOPs, of the second multiplexed packet stream ST2 as shown in the lower part of the figure. In an alternative embodiment, the 401st to 800th GOPs of the second multiplexed packet stream ST2, in which no packet loss has been detected in the demultiplexing process during the time period t0 to t1, may be passed to the reproduction process without being corrected.

It should be appreciated that 100% demultiplexing is possible using only the first multiplexed packet stream ST1 if packet loss occurs in a certain number, i.e., a number equal to or less than the critical value for burst error resistance Nα₁=10, of GOPs of the first multiplexed packet stream ST1. In addition, two streams of the first multiplexed packet streams ST1 and ST2 may be prepared to have different critical values for burst error resistance Nα₁ and Nα₂, and hierarchically multiplexed with a certain time difference, thereby to allow mutual correction to be performed during the demultiplexing.

Moreover, the method according to the present embodiment increases the possibility that the demultiplexing can accept burst error that exceeds the maximum values for burst error resistance Nα₁ and Nα₂. For example, it is now assumed that, in the time period t1 to t3 shown in FIG. 7, packet loss occurs in 420 (≧400) GOPs, i.e., the 1181st to 1600th GOPs, of the second multiplexed packet stream ST2.

In this case, the 420 GOPs, i.e., the 1181st to 1600th GOPs, of the second multiplexed packet stream ST2, in which packet loss occurs, can be compensated using 420 GOPs, i.e., the 1181st to 1600th GOPs, of the first multiplexed packet stream ST1, which will be transmitted in the next time period t2 to t3, if they can be demultiplexed (if no packet loss occurs).

In such a way, the method according to the present embodiment increases the possibility that the demultiplexing can accept burst error that exceeds the maximum values for burst error resistance Nα₁ and Nα₂. The embodiment shown in FIG. 7 uses Nα₁=10 and Nα₂=400 as the critical values for burst error resistance, so that the reproduction actual time will be 200 seconds when the maximum value for burst error resistance is Nα₂=400 and one GOP comprises IP packets for 0.5 seconds, and the demultiplexing can thus accept burst error of 200 seconds or less.

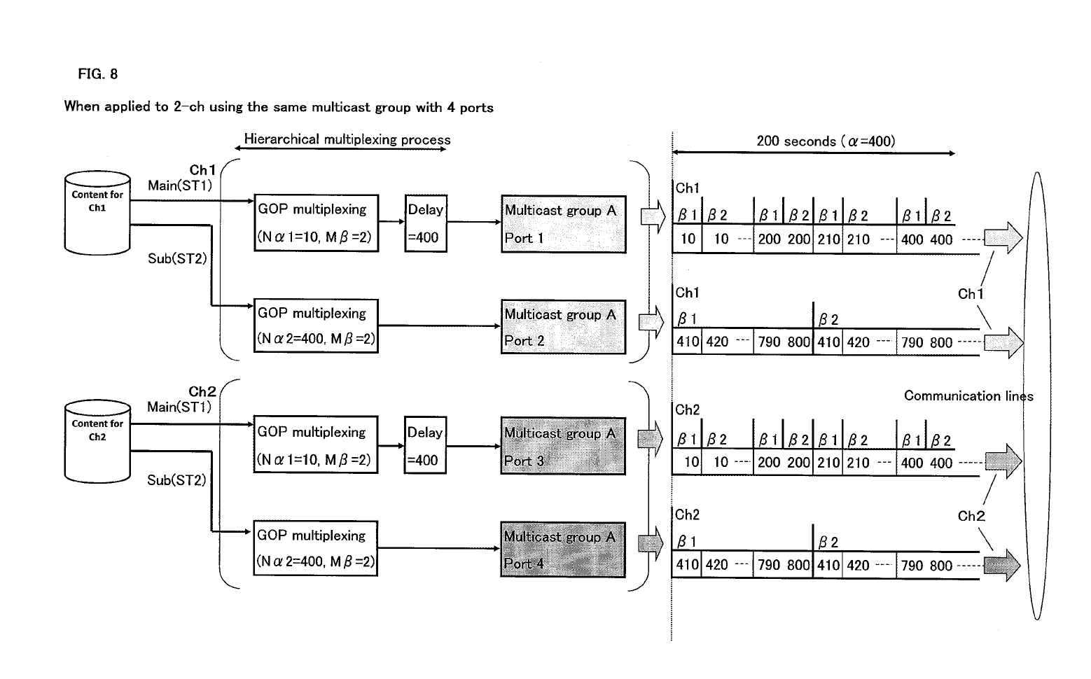

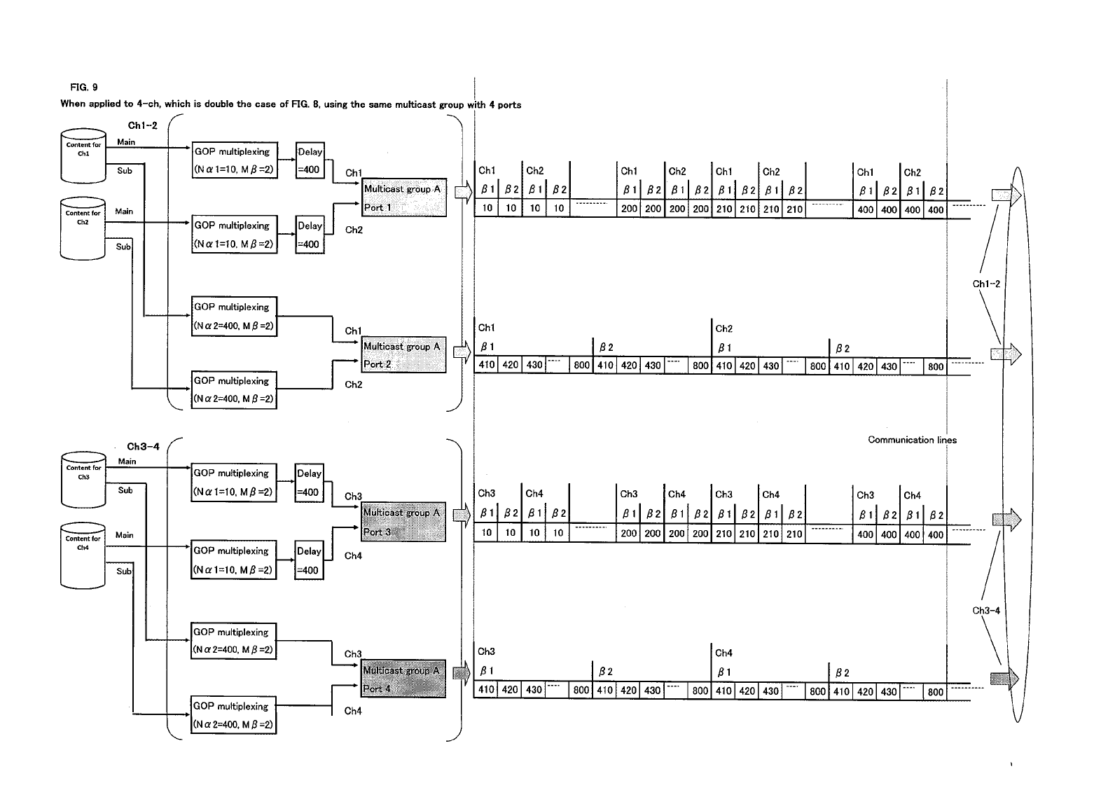

Referring again to FIG. 1, the embodiment shown is configured to transmit the first multiplexed packet stream ST1 and the second multiplexed packet stream ST2, which are hierarchically multiplexed, from two different multicast address ports No. 1 and 2 of the same multicast group, but the number of ports and the number of channels are not limited, and any number of ports and any number of channels can be applied. For example, the present invention can be carried out using two channels as shown in FIG. 8 or four channels as shown in FIG. 9.

In the transmission scheme as shown in FIG. 8, two kinds of contents are prepared for the first channel and the second channel, and the first multiplexed packet stream ST1 and the second multiplexed packet stream ST2 are generated from each content like in the above-described embodiments. For the first channel, either one of the first multiplexed packet stream ST1 and the second multiplexed packet stream ST2 (the first multiplexed packet stream ST1 in the illustrated example) is delayed by the transmission time for 400 GOPs relative to the other, and they are transmitted from the two different multicast address ports 1 and 2 to the communication lines 4. At the same time, for the second channel, either one of the first multiplexed packet stream ST1 and the second multiplexed packet stream ST2 (the first multiplexed packet stream ST1 in the illustrated example) is delayed by the transmission time for 400 GOPs relative to the other, and they are transmitted from the two different multicast address ports 3 and 4 to the communication lines 4.

In the modified transmission scheme as shown in FIG. 9, four kinds of contents are prepared for the first to fourth channels, and the first multiplexed packet stream ST1 and the second multiplexed packet stream ST2 are generated from each content like in the above-described embodiments. In this embodiment, four first multiplexed packet streams ST1 and four second multiplexed packet streams ST2 are generated. In this case, two channels share one multicast port address, and the streams are transmitted with a rate or a time period twice those in the transmission scheme shown in FIG. 8.

More specifically, from the multicast address port 1, the first multiplexed packet stream ST1 for the first channel and the first multiplexed packet stream ST1 for the second channel are delayed by the transmission time for 400 GOPs relative to the others, and transmitted to the communication lines 4. From the multicast address port 2, the second multiplexed packet stream ST2 for the first channel and the second multiplexed packet stream ST2 for the second channel are transmitted to the communication lines 4. From the multicast address port 3, the first multiplexed packet stream ST1 for the third channel and the first multiplexed packet stream ST1 for the fourth channel are delayed by the transmission time for 400 GOPs relative to the others, and transmitted to the communication lines 4. From the multicast address port 4, the second multiplexed packet stream ST2 for the third channel and the second multiplexed packet stream ST2 for the fourth channel are transmitted to the communication lines 4.

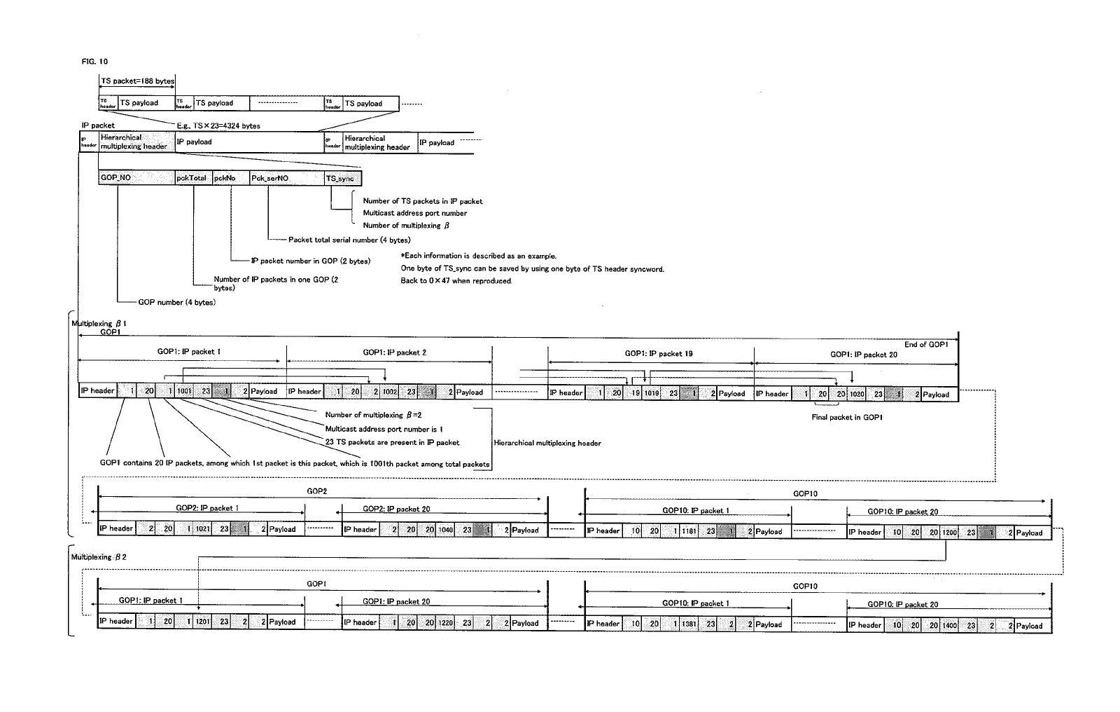

Referring again to FIG. 1, in order for the terminal device 3 to readily progress the demultiplexing process, the multicast server 1 may be configured to, when performing the hierarchical multiplexing of content, insert a hierarchical multiplexing header in an IP packet, thereby allowing the terminal device 3 to use it at the time of packet loss correction in terms of a GOP and GOP loss correction. FIG. 10 is a diagram illustrating an embodiment in which such hierarchical multiplexing headers are inserted in IP packets.

When the content is MPEG-TS, there is known a method of determining packet missing by checking discontinuity of a “continuity counter” contained in each TS packet header, but this method is not suitable for correction of packet loss and correction of GOPs because this method merely presents missing of TS packets. This is because the conventional method uses only information with regard to the discontinuity of a continuity counter and has problems such that considerable retrieval steps are necessary when performing correction in terms of a GOP like in the present embodiment, and information regarding the multiplexing and the hierarchical multiplexing cannot be acquired. The present embodiment is therefore designed such that header information for the hierarchical multiplexing is added in each IP packet, as shown in FIG. 10.

As shown in FIG. 10, each IP packet contains an inserted hierarchical multiplexing header, which stores various information items, i.e., GOP_NO that indicates the GOP number; pckTotal that indicates the number of IP packets in one GOP; pckNo that indicates the IP packet number in the GOP; Pck_serNO that indicates the packet total serial number; and TS-sync that indicates the number of TS packets in the IP packet, the multicast address port number and the number of multiplexing Mβ, in this order with predetermined byte counts. For example, referring to data of IP packet 1 of multiplexing β1 shown in the figure, “1, 20, 1, 1001, 23, 1, and 2” are recorded in the hierarchical multiplexing header, and information can thus be obtained that: GOP 1 includes 20 IP packets; IP packet 1 is the 1st packet among the 20 IP packets; IP packet 1 is the 1001st one among the total IP packets; the IP packet includes 23 TS packets; the multicast address port number is 1; and the number of multiplexing Mβ is 2.

Such a packet structure allows the detection and correction of packet loss in terms of a GOP to easily be performed while at the same time the multicast address port number can be used to detect the multiplexed stream β in terms of a multicast group, so that the multiplexing in terms of a GOP can be achieved using the same multicast address. Moreover, the added packet total serial number is to be a unique packet number for all the streams (β1-β2), and immediate detection can thus be possible as to where loss occurs.

Again with reference to FIG. 1, a method of reproducing the stream in the terminal device 3 when packet loss occurs will be described.

Now considering a case where packet loss occurs during the streaming of content, it may be easy to conceive of a method of discarding the lost packets and performing reproduction, but when the lost packets in a GOP are discarded, distorted video is to be reproduced until the reference is reset at the head of the next GOP, thus being problematic. Another problem is that the reproduction decoder may abort its operation due to error. To overcome these problems, it may be considered to perform discard in terms of a GOP, in which case any video distortion will not occur because the reference is reset at the head of the next GOP.

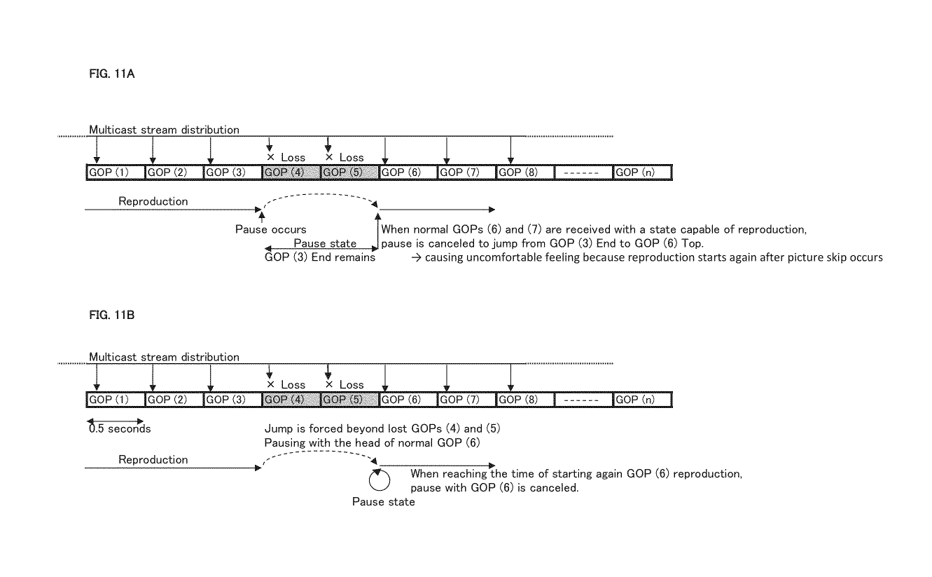

However, if GOP (4) and GOP (5) are discarded as shown in FIG. 11A, the video pauses at the end of GOP (3) when the GOPs are discarded, and continues to hold this state until the head of normal, next GOP (6) appears. This may cause the viewer to feel uncomfortable because she/he views such video that pauses at GOP (3) during the reproduction, holding the state for a little, thereafter starting again the reproduction when the head of the next GOP (6) appears.

In contrast, the present embodiment discards GOPs like in the above, provided that the GOP loss cannot be corrected even by the hierarchically multiplexing method. The hierarchically multiplexing method can determine which GOPs are lost and which next ones are normal, so that when GOP loss occurs, jump may be forced to the head of the next, normal GOP for the pause there, as shown in FIG. 11B. The pause state is held until the time of initiating the reproduction of the next GOP, and the reproduction is started again at that time without any change. This results in the continuation of reproduction from the pause state (still picture) without any video skip thereby to mitigate the viewer's uncomfortable feeling. Video for one second may be lost when the interval of GOPs is 0.5 seconds and two GOPs are lost, for example, but any video skip does not occur even after the pause of one second so that continuous video can be viewed, because the jump is forced, immediately before the pause, to the head of the next GOP. This mitigates the uncomfortable feeling.

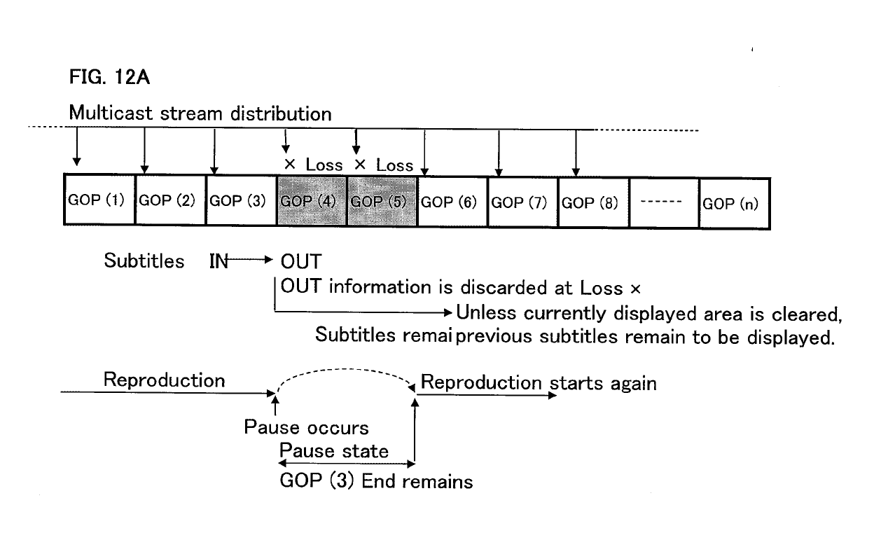

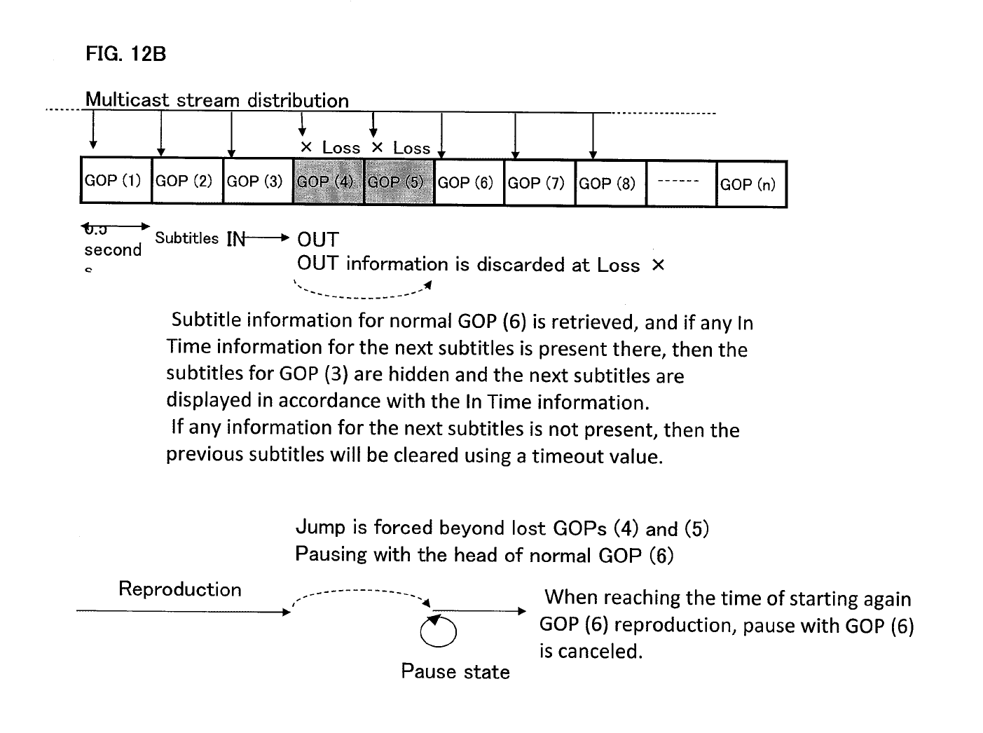

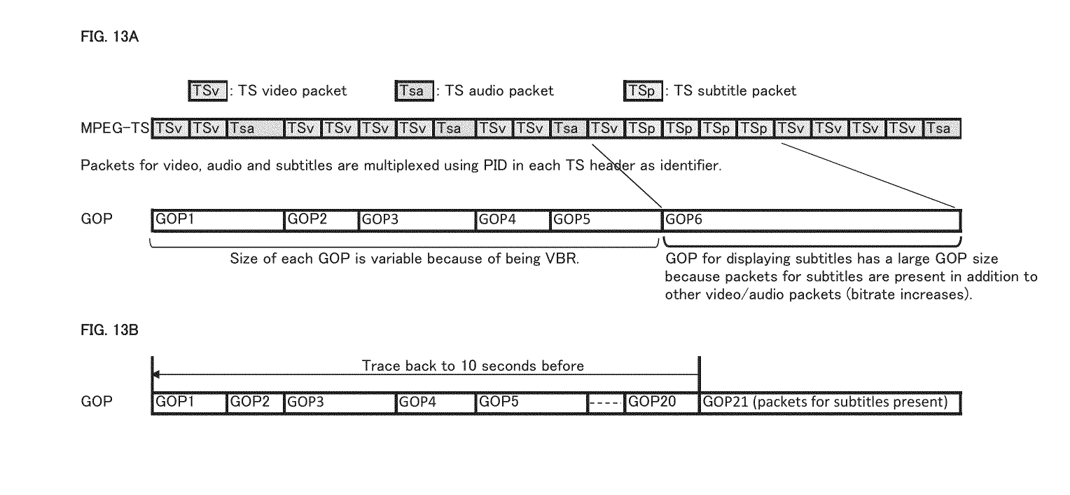

A method of displaying subtitles when packet loss occurs will be described below, which is applicable to the terminal device 3. A method of multiplexing a stream for subtitles to a video stream of MPEG-TS has conventionally been used, but also in this case, when packet loss occurs, troubles may occur like in the video stream, such as that subtitles are not displayed and/or do not disappear, and the displayed subtitles are distorted. To display and hide subtitles in synchronization with the replay time of the corresponding video stream, packets for subtitles hold therein In Time (display initiating time) and Out Time (hiding time) information, which allows the subtitles to be displayed and hidden in synchronization with the video. For example, provided that the Out Time information for subtitles was stored in GOP (4) as shown in FIG. 12A, if GOP (4) and GOP (5) are discarded, then problem may occur that the subtitles do not disappear when the next, normal GOP (6) is reproduced.

To cope with this, according to the present embodiment, a method of displaying subtitles as will be described below is further added to the above-described method of reproducing a stream, in which GOPs may be discarded when the GOP loss cannot be corrected even by the hierarchically multiplexing method. Note that data for subtitles can be responsible for any of bitmap format and text format.

More specifically, as shown in FIG. 12B, subtitle information for the normal GOP (6) may be retrieved, and if any In Time information for the next subtitles is present there, then the subtitles for GOP (3) are hidden and the next subtitles are displayed in accordance with the In Time information. If any information for the next subtitles is not present, then the previous subtitles will be cleared using a timeout value.

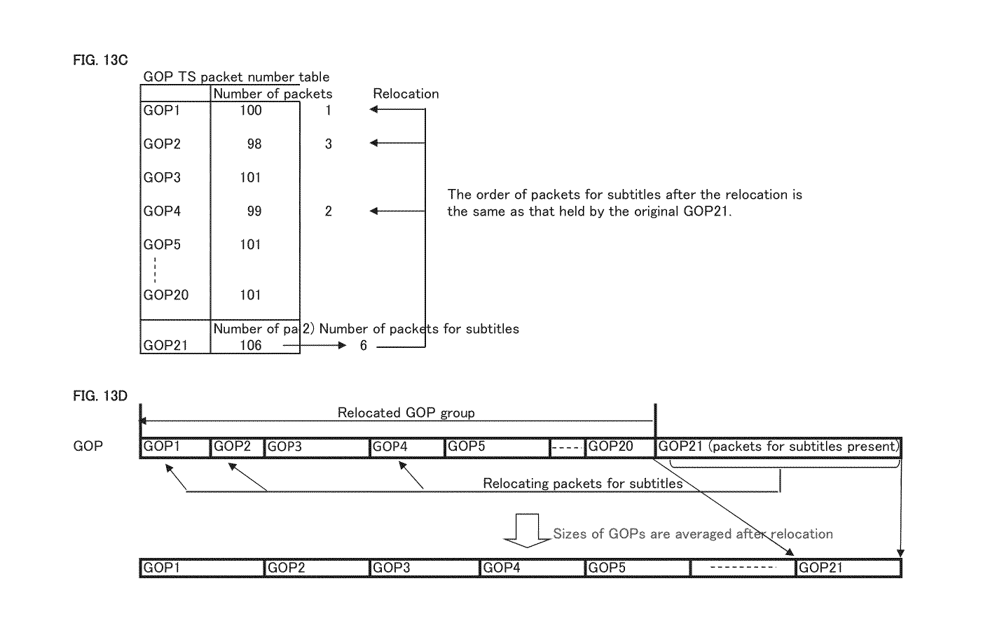

When multiplexing a stream for subtitles to a video stream of MPEG-TS during the creation of content, a conventional encoder or TS multiplexer (any of hardware and software) arranges the stream for subtitles intensively in a GOP associated with the timing of displaying the subtitles. Therefore, if multicast distribution is conducted, then, as shown in FIG. 13A, bit rate (bit count) may increase particularly in a certain location (GOP (6)), resulting in a problem that packet loss occurs in a concentrated form. Unicast distribution may be less affected than multicast distribution, but depending on the bandwidth of a communication path, the reproduction buffer may underrun with a part in relation to the stream for subtitles, leading to latency issues in the video reproduction.

To overcome such problems, according to the present embodiment, packets for subtitles in MPEG-TS may be multiplexed in an averaging manner. More specifically, packets for subtitles located intensively in a certain GOP are detected as shown in FIG. 13B; previous GOPs to that GOP are searched; and the packets for subtitles are relocated in low-bit-rate locations of respective GOPs, as shown in FIG. 13C, to thereby perform averaging of bit rate across the whole, as shown in FIG. 13D. According to the present embodiment, the search range of GOPs for relocation may be, but not limited to, GOPs of 10 seconds. In an alternative embodiment, targets may be GOPs with no packet for subtitles, between each two GOPs which contain packets for subtitles. As shown in FIG. 13C, a TS packet number table may be created on GOP basis by detecting the number of packets for subtitles, which require relocation, from a GOP in which packets for subtitles are present, and searching the number of TS packets which will be accepted by each GOP for relocation. The relocation may be performed in an averaging or smoothing manner such that the packets for subtitles requiring relocation are relocated in terms of a GOP on the basis of the TS packet number table. The order of packets for subtitles after the relocation may have to be the same as that of the original packets for subtitles.

Summarizing the above paragraph, this method is a method of creating content in which, for a packet stream of MPEG-TS standard that includes video data, audio data and subtitle data, volumes of data for subtitles contained in respective GOPs that constitute the packet stream are detected, and if the smoothness of the volumes of data is a predetermined smoothness or more, then the number of packets for subtitles in each GOP is re-adjusted so that the smoothness is less than the predetermined smoothness.

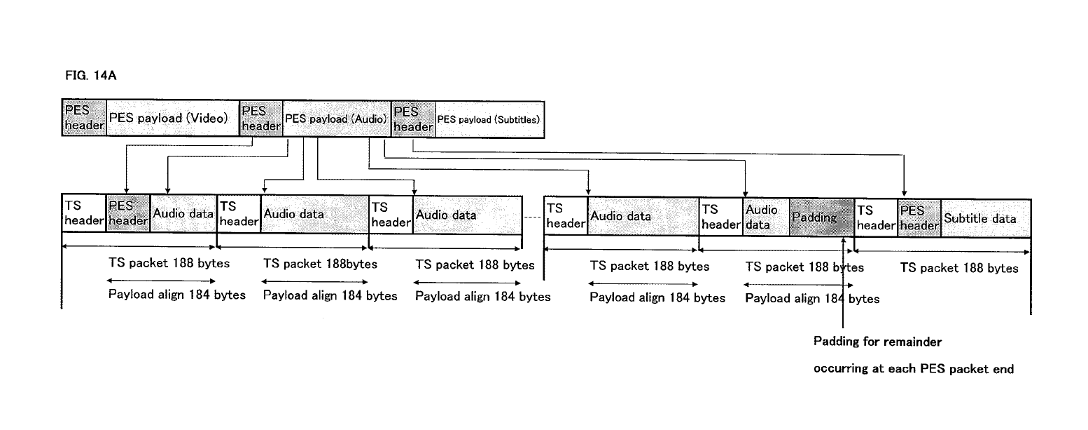

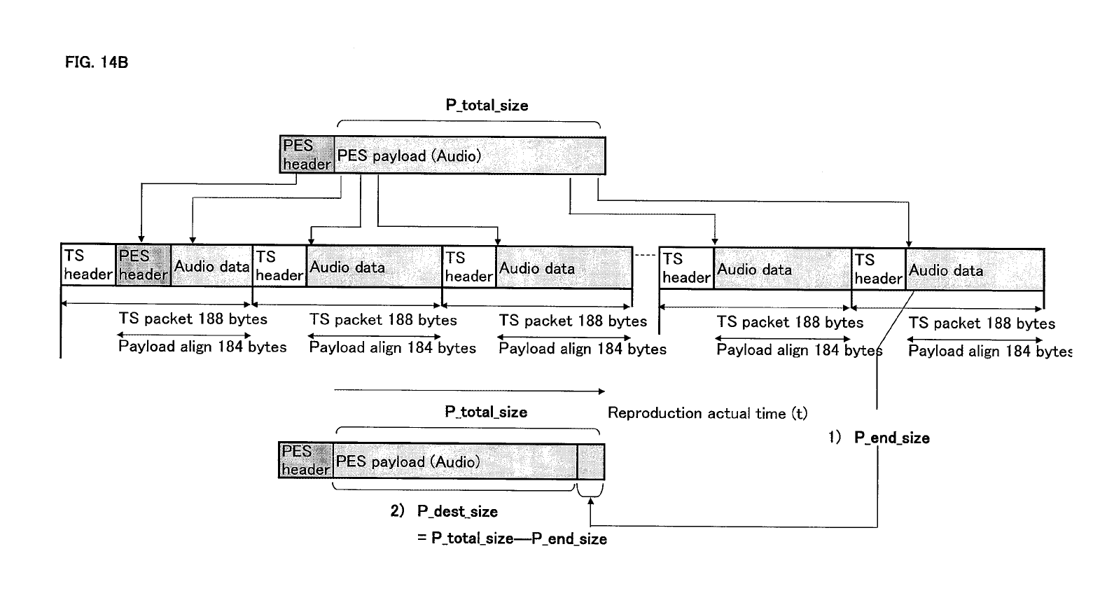

When multiplexing streams for video, audio and subtitles, etc. into an MPEG-TS video stream during the creation of content, a conventional encoder or TS multiplexer (any of hardware and software) as described in the preceding paragraphs generates TS packets from PES packets in terms of a TS packet of 188 bytes, so that each PES packet end portion leaves a remainder. According to an existing technique, as shown in FIG. 14A, a method is known in which the multiplexing is performed in terms of 188 bytes by filling the remainder with Padding (Null Pack).

In multicast distribution affected seriously by packet loss, however, redundant and unnecessary data due to the above padding may have to be eliminated as much as possible because it is regarded as important to reduce the bit rate to the extent possible and suppress the influence by packet loss to the minimum. Also in unicast distribution, it is preferred to reduce the bit rate as much as possible, such as when the communication bandwidth is not sufficient.

According to the present embodiment, a method may be employed in which padding for remainder is eliminated as much as possible when the multiplexing of TS packets from PES packets is performed. More specifically, as shown in FIG. 14B, in a process for TS multiplexing from PES packets, the size of the remainder of PES packet end (P_end_size) is detected. The above remainder size (P_end_size) is then subtracted from the size of the target PES packet (Audio packet in the present embodiment) (P_total_size) to calculate P_dest_size. The P_dest_size and the reproduction actual time (t) for the PES packet are then used as the basis to calculate a bit rate (P_dest_rate). Finally, the P_dest_rate is used as a target bit rate to encode again a stream thereby generating again PES packets.

PES packets obtained in the above manner are smoothed in terms of an align of TS multiplexing (TS packet payload 184 bytes) to suppress padding as minimum necessary. Note that the present embodiment exemplifies Audio packets, but may be applicable to other packets, such as for video and subtitles.

### DESCRIPTION OF REFERENCE NUMERALS

1 . . . Multicast server
2 . . . WiFi wireless LAN
3 . . . Terminal device
4 . . . Communication lines
5 . . . Wireless LAN line

What is claimed is:

1. A distribution device for transmission packets, the distribution device distributing, by multicast or unicast, content stream data to a terminal via a communication path, the content stream data comprising closed GOPs that include at least video data and audio data, the distribution device comprising:
a first conversion means that converts the content stream data to a first multiplexed packet stream so that a group of Nα₁ closed GOPs in order from a head is in turn multiplexed into a plurality of GOP groups in terms of a closed GOP;
a second conversion means that converts the content stream data to a second multiplexed packet stream so that a group of Nα₂ closed GOPs in order from a head is in turn multiplexed into a plurality of GOP groups in terms of a closed GOP; and
a distribution means that distributes the first multiplexed packet stream and the second multiplexed packet stream with a time difference corresponding to the Nα₂ closed GOPs,
where Nα₁ and Nα₂ are natural numbers, Nα₁<Nα₂, and Nα₂ is multiple of Nα₂.

2. The distribution device for transmission packets as recited in claim 1, wherein one of the first multiplexed packet stream and the second multiplexed packet stream of which the number of closed GOPs (Nα₁, Nα₂) is smaller than that of the other is delayed to the other with the time difference.

3. The distribution device for transmission packets as recited in claim 1, wherein, when the content stream data is distributed by multicast,
the first multiplexed packet stream and the second multiplexed packet stream are distributed using same multicast group but with different multicast address port numbers.

4. The distribution device for transmission packets as recited in claim 3, wherein the first multiplexed packet stream and the second multiplexed packet stream are distributed via a plurality of channels.

5. The distribution device for transmission packets as recited in claim 1, further comprising:
a first correction means that, when the first multiplexed packet stream transmitted to the terminal is demultiplexed and a lost GOP is detected among the Nα₁ closed GOPs, performs correction using another GOP among the plurality of GOP groups;
a second correction means that, when the second multiplexed packet stream transmitted to the terminal is demultiplexed and a lost GOP is detected among the Nα₂ closed GOPs, performs correction using another GOP among the plurality of GOP groups; and
a third correction means that, when an uncorrectable GOP is detected in the first correction means and the second correction means, corrects the uncorrectable GOP using a corresponding GOP of the first multiplexed packet stream or the second multiplexed packet stream that has been precedingly distributed.

6. The distribution device for transmission packets as recited in claim 5, wherein, when an uncorrectable GOP is detected in the third correction means, the uncorrectable GOP is discarded as loss.

7. The distribution device for transmission packets as recited in claim 6, further comprising a means that, when an uncorrectable GOP is detected in the third correction means and content stream data of which the uncorrectable GOP is discarded as loss is reproduced, jumps for pause to a head of a GOP next to the discarded GOP after GOPs preceding the discarded GOP have been reproduced, the pause continuing until the time of initiating reproduction of the next GOP.

8. The distribution device for transmission packets as recited in claim 7, wherein the content stream data includes subtitle data and subtitle header information, the subtitle data comprising text data or picture data, and wherein the distribution device further comprises a means that:
retrieves the subtitle header information of a GOP previous to the discarded GOP and the subtitle header information of a GOP next to the discarded GOP;
when subtitle insertion information is detected in both the GOPs previous to and next to the discarded GOP, hides the subtitle data of the GOP previous to the discarded GOP and displays the subtitle data of the GOP next to the discarded GOP in accordance with the subtitle header information; and
when subtitle insertion information is detected in the GOP previous to the discarded GOP but is not detected in the GOP next the discarded GOP, clears the subtitle data using a timeout value.

9. The distribution device for transmission packets as recited in claim 1, further comprising a means that inserts a header in each GOP of the first multiplexed packet stream and the second multiplexed packet stream, the header comprising: order of GOPs; number and order of IP packets included in the GOP; order of IP packets among total IP packets included in the content stream data; number of TS packets included in the GOP; multicast address port number; and number of multiplexing.

10. A distribution device for transmission packets, the distribution device distributing, by multicast or unicast, content stream data to a terminal via a communication path, the content stream data comprising frames that include audio data, the distribution device comprising:
a first conversion means that converts the content stream data to a first multiplexed packet stream so that a group of Nα₁ frames in order from a head is in turn multiplexed into a plurality of frame groups in terms of a frame;
a second conversion means that converts the content stream data to a second multiplexed packet stream so that a group of Nα₂ frames in order from a head is in turn multiplexed into a plurality of frame groups in terms of a frame; and
a distribution means that distributes the first multiplexed packet stream and the second multiplexed packet stream with a time difference corresponding to the Nα₂ frames,
where Nα₁ and Nα₂ are natural numbers, Nα₁<Nα₂, and Nα₂ is multiple of Nα₂.
